(19) United States
(12) Patent Application Publication
(10) Pub. No.: US 2019/0251802 A1
(43) Pub. Date: Aug. 15, 2019

(54) TABLET POS TERMINAL

(71) Applicant: PAX COMPUTER TECHNOLOGY (SHENZHEN) CO., LTD., Shenzhen, guangdong (CN)

(72) Inventors: Shaowen Luo, Shenzhen, Guangdong (CN); Chenghe Yang, Shenzhen, Guangdong (CN); Yan Chen, Shenzhen, Guangdong (CN); Xiaoping Lei, Shenzhen, Guangdong (CN); Guohua Huang, Shenzhen, Guangdong (US)

(21) Appl. No.: 15/766,042

(22) PCT Filed: Mar. 12, 2018
(86) PCT No.: PCT/CN2018/078708

§ 371 Date: Apr. 5, 2018

(30) Foreign Application Priority Data
Feb. 11, 2018 (CN) 201820251616.X

(51) Int. Cl. G07G 1/12; G06Q 20/20; G07G 1/00; G06F 3/02

(52) U.S. Cl. CPC G07G 1/12; G06F 3/0202; G07G 1/0045; G06Q 20/204

(57) ABSTRACT

A tablet POS terminal, comprises a casing, a tablet computer module arranged in the casing and an integrated payment module arranged in the casing; the casing is flat; a window for exposing a screen of the tablet computer module is correspondingly provided in the casing; the integrated payment module is arranged at one side of the tablet computer module; the integrated payment module is electrically connected with the tablet computer module; and a switch button configured to control powering on and off of the tablet computer module is provided at the casing. The present application reduces occupied space through arranging the casing in a flat shape so as to be conveniently held and used. Diversified transaction payments can be carried out through the integrated payment module. The present application can be used more conveniently, and the physical experiences can be better; more operational requirements can be met.

### FIELD OF THE INVENTION

The present application relates to the field of payment terminal devices, and more particularly to a tablet POS terminal.

### DESCRIPTION OF THE RELATED ART

The Chinese meaning of POS (point of sales terminal) is “point-of-sale”, and its full name is referred as an information management system for point-of-sale, which function is a cash or easy-to-cargo limit teller. With the diversification of transaction payment modes and the improvement of the convenience of payment, the transaction terminal devices are used increasingly. However, requirements and physical experiences of the client during the transaction are also increasingly higher. When a customer conducts transaction payment at commercial tenants, the detailed information of the transaction is usually expected to be seen, or the payment can be directly carried out after the commodities are selected. However, most of the current transaction terminals adopt a handheld POS device, with the screen thereof is relatively small, and the corresponding functions are relatively limited. Consequently, the operational requirements and physical experiences of the user cannot be met.

### SUMMARY OF THE INVENTION

In summary, an object of the present application is to provide a tablet POS terminal, in order to solve the problems existing in the prior art that the functions of a transaction terminal are limited, and the operational requirements and physical experiences of the user cannot be met.

In order to achieve the above objects, the technical solutions of the present application is to provide a tablet POS terminal, comprising a casing, a tablet computer module arranged in the casing and an integrated payment module arranged in the casing; the casing is in a flat shape; a window exposing a screen of the tablet computer module is correspondingly provided at the casing; the integrated payment module is arranged by a side of the tablet computer module; the integrated payment module is electrically connected with the tablet computer module; and a switch button configured to control powering on and off of the tablet computer module is provided at the casing.

Further, the integrated payment module includes a inserting type card reader module configured for reading information from a magnetic stripe card and a chip card; a non-contact type card reader module configured for wirelessly reading information from a non-contact card; a laser scanner configured for scanning codes; a fingerprint identification module configured for carrying out fingerprint identification; and a card slot configured for the insertion of a magnetic strip card or a chip card into the inserting type card reader module is correspondingly provided at the casing; the card slot is arranged in the middle of the thickness of the casing.

Further, the inserting type card reader module is arranged in the middle of the bottom of the casing, and the non-contact type card reader module is arranged at a side of the inserting type card reader module.

Further, an indicator light is provided in the casing configured for prompting when the non-contact type card reader module is in use; a light hole is provided at the casing and is arranged in a position corresponding to the indicator light; and a light non-opaque cover plate configured for covering the light hole is provided at the casing.

Further, the integrated payment module further includes a camera configured for shooting images; the camera and the fingerprint identification module are respectively arranged at two sides of the non-contact type card reading module; and the camera, the non-contact type card reader module and the fingerprint identification module are arranged at the same side of the inserting type card reader module.

Further, the integrated payment module further includes a keyboard configured for entering information; and the keyboard is arranged by another side of the inserting type card reader module.

Further, the integrated payment module further includes an anti-peeping cover configured for covering the keyboard.

Further, a first magnetic attraction is provided in the casing and arranged at the periphery of the keyboard; and a second magnetic attraction is provided at the bottom of the anti-peeping cover and arranged to cooperate with the first magnetic attraction.

Further, the keyboard includes a plurality of rice-grain keys; and holes configured for exposing the rice-grain keys are correspondingly provided at the casing.

Further, a prompt colored chart is provided at a side surface of the casing 10 and is arranged in a position corresponding to the card slot.

Further, the laser seamier is laterally arranged at the bottom of the casing.

The beneficial effects of the tablet POS terminal as provided by the present application are as follows: compared with the prior art, the present application reduces occupied space through arranging the casing in a flat shape so as to be conveniently held and used. The tablet computer module and the integrated payment module are arranged in the casing so as to improve the using experience and using functions through the tablet computer module. Meanwhile, diversified transaction payments can be carried out through the integrated payment module. Consequently, the present application can be used more conveniently by users, and the physical experiences can be better; more operational requirements of the users can be met.

### BRIEF DESCRIPTION OF THE DRAWINGS

In order to illustrate the technical solutions provided by the embodiments of the present application more clearly, drawings required to be used in the description of the embodiments or in the prior art will be introduced briefly hereinafter. Obviously, the drawings in the following description are only for some embodiments of the present application. For those skilled in the art, other drawings can be obtained according to the drawings provided herein without creative efforts.

FIG. 1 is a structural schematic view of a tablet POS terminal as provided according to an embodiment of the present application;

FIG. 2 is a structural schematic top view of the tablet POS terminal shown in FIG. 1;

FIG. 3 is a structural schematic front view of the tablet POS terminal shown in FIG. 1.

Wherein, main reference numerals in the drawings:
10—Casing; 11—Window; 12—Switch button; 13—Light sensing hole; 14—Power indicator light; 15—Volume control button; 16—Recess; 20—Tablet computer module; 30—Integrated payment module; 31—inserting type card reader module; 311—Card slot; 32—Non-contact type card reader module; 321—Indicator light; 33—Fingerprint identification module; 34—Camera; 35—Keyboard; 351—Rice-grain keys; 36—Laser scanner.

### DETAILED DESCRIPTION OF THE PREFERRED EMBODIMENTS

In order to enable technical problems, technical solutions, and advantages of the present application to be clearer and more understandable, the present application will be further described in detail hereinafter with reference to the drawings and embodiments. It should be understood that the specific embodiments described hereinafter are only intended to illustrate but not to limit the present application.

It should be noted that when an element is referred to as being “fixed” or “provided/arranged” to another element, it can be provided directly or indirectly to the other element. When an element is referred to as being “connected” to another element, it can be connected directly to the other element or indirectly to the other element.

In addition, the terms “first” and “second” are used only for purposes of description, and are not understood to indicate or imply the relative importance or to implicitly indicate the number of the indicated technical features. Thus, the features limited by “first”, “second” can expressly or implicitly includes one or more of said features. In the description of the present application, the meaning of “multiple” are two or more than two, unless specifically states otherwise, and the meaning of “plurality” is one or more than one, unless explicitly states otherwise.

In the description of the present application, it should be understood that the term “center”, “length”, “width”, “thickness”, “upper”, “lower”, “front”, “back”, “left”, “right”, “vertical”, “horizontal”, “top”, “bottom”, “inner” and “outer” and the like, the orientation or the position relationship indicated by said items is based on the orientation or position relationship shown in the drawings, which is only intended to facilitate the description of the present application and simplify the description and is not to indicate or imply that the indicated device or element must possess a specific orientation, or must be constructed and operated in a specific orientation. Therefore, said items are not to be understood to be the limitation to the present application.

It should be noted that in the description of the present application, the terms “installed”, “connected” and “connection” should be interpreted comprehensively, unless there are explicitly statements and limitations. For example, the connection can be fixedly connected, detachably connected, integrally connected, or it can be mechanically connected, electrically connected, directly connected or indirectly connected through an intermediate medium, or it can be an inner connection between two elements or an interaction relationship between the two elements. For the ordinary skilled in the art, the specific meaning of the above terms in the present application can be interpreted in accordance with specific situations.

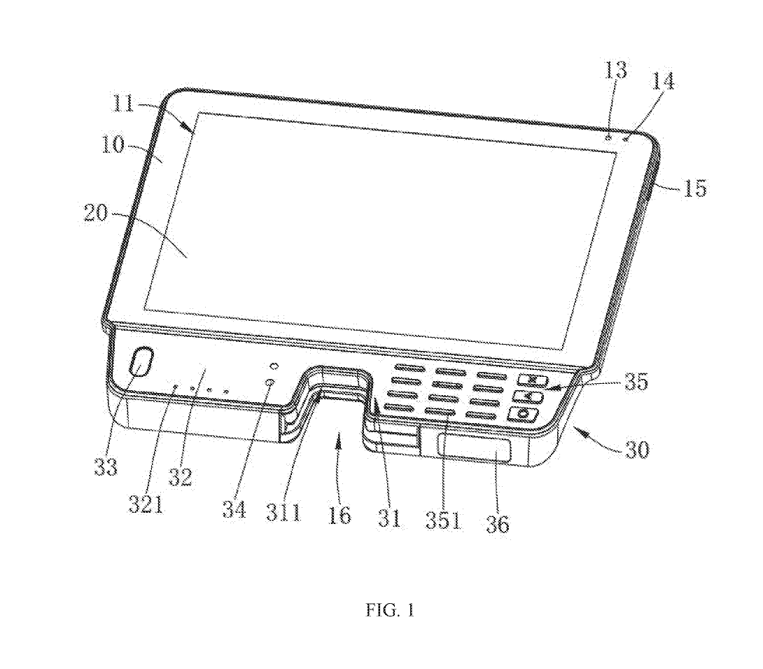

Referring to FIG. 1 to FIG. 3, a tablet POS terminal provided by the present application will be described hereinafter. The tablet POS terminal comprises a casing 10, a tablet computer module 20 and an integrated payment module 30. Wherein, the casing 10 is in a flat shape. The tablet computer module 20 and the integrated payment module 30 both are arranged in the casing 10, so that the appearance of the tablet POS terminal is flat. As a result, the tablet POS terminal is conveniently to be held and used, and the occupied space thereof is reduced. The casing 10 is correspondingly provided with a window 11 exposing a screen of the tablet computer module 20 so as to facilitate operations to the tablet computer module 20. The integrated payment module 30 is provided at one side of the tablet computer module 20 and can be conveniently arranged. Specifically, in this embodiment, the integrated payment module 30 is arranged at the bottom of the tablet computer module 20, so that the size of the tablet POS terminal can be arranged smaller, and the structure thereof can be more compact. Of course, in other embodiments, the integrated payment module 30 is arranged at the top, the left side or the right side of the tablet computer module 20. The integrated payment module 30 is electrically connected with the tablet computer module 20, so that the integrated payment module 30 can be controlled by the tablet computer module 20; or the integrated payment module 30 can be supplied with power through the tablet computer module 20; or the tablet computer module 20 can be conveniently communicated with the integrated payment module 30 so as to facilitate the transaction. The casing 10 is provided with a switch button 12 configured to control powering on and off of the tablet computer module 20, so that the tablet computer module 20 can be conveniently controlled. In the embodiment, the switch button 12 is arranged at a corner of the top side surface of the casing 10. In other embodiments, the switch button 12 can also be arranged at other positions of the top side surface of the casing 10, or can be arranged at other positions of the casing 10.

Compared with the prior art, the tablet POS terminal provided by the present application, wherein the casing 10 is in a flat shape, so that the tablet POS terminal is conveniently to be held and used, and the occupied space thereof is reduced. The tablet computer module 20 and the integrated payment module 30 are provided in the casing 10 so as to improve the using experience and using functions through the tablet computer module 20. Meanwhile, diversified transaction payments can be carried out through the integrated payment module. Consequently, the present application can be used more conveniently by users, and the physical experiences can be better; more operational requirements of the users can be met.

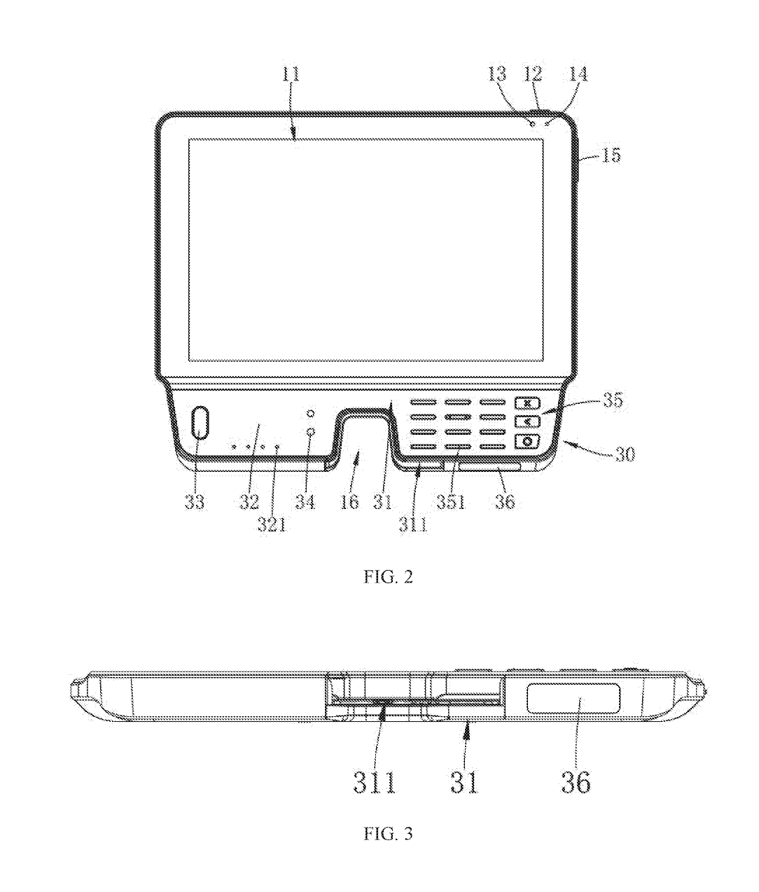

Further, referring to FIG. 1 and FIG. 2, as an embodiment of the tablet POS terminal provided by the present application, a volume control button 15 is provided on the casing 10 so as to control the volume of the tablet computer module 20. In the embodiment, the volume control button 15 is arranged at one corner of the right side surface of the casing 10. In other embodiments, the volume control button 15 can also be arranged at other positions of the top side surface of the casing 10, or can be arranged at other positions of the casing 10

Further, referring to FIG. 1 and FIG. 2, as an embodiment of the tablet POS terminal provided by the present application, a power indicator light 14 is provided at the casing 10 and is arranged in a position corresponding to the top of the tablet computer module 20, so that states of the power supply, such as the state of the charging, the state of full charged, the state of battery low can be conveniently indicated.

Further, referring to FIG. 1 and FIG. 2, as an embodiment of the tablet POS terminal provided by the present application, a light sensor (not shown) is provided at the casing 10 and arranged in a position corresponding to the top end of the tablet computer module 20. A light sensing hole 13 is provided at the casing 10 and is arranged in a position corresponding to the light sensor, so that the tablet computer module 20 can detect the external brightness to adjust the brightness of the tablet computer module 20.

Further, referring to FIG. 1 to FIG. 3, as an embodiment of the tablet POS terminal provided by the present application, the integrated payment module 30 includes a inserting type card reader module 31 configured for reading information from a magnetic stripe card or a chip card; a non-contact type card reader module 32 configured for wirelessly reading information from a non-contact card; a laser scanner 36 configured for scanning codes; and a fingerprint identification module 33 configured for carrying out fingerprint identification. The casing 10 is correspondingly provided with a card slot 311 configured for the insertion of a magnetic strip card or a chip card into the inserting type card reader module 31. The card slot 311 is arranged in the middle of the thickness of the casing 10. The inserting type card reader module 31 is provided, so that the magnetic stripe card or the chip card can be used for carrying out transactions and payments. The non-contact type card reader module 32 is provided, so that a non-contact card can be used for carrying out transactions and payments. The laser scanner 36 is provided, so that code scanning transactions and payments can be carried out. The fingerprint identification module 33 is provided, so that the fingerprint identification transactions and payments can be carried out. Meanwhile fingerprint identification can be used to identify the control authority of the user to the tablet computer module 20 and the integrated payment module 30 so as to improve the safety in use. The card slot 311 is arranged in the middle of the thickness of the casing 10 so as to reduce the thickness occupied by the inserting type card reader module 31 and to reduce the thickness of the tablet POS terminal.

Further, referring to FIG. 1 and FIG. 2, as an embodiment of the tablet POS terminal provided by the present application, the inserting type card reader module 31 is arranged in the middle of the bottom side of the casing 10, and the non-contact type card reader module 32 is arranged at one side of the inserting type card reader module 31. Said structure can be arranged conveniently, and meanwhile, due to spaces respectively occupied by the inserting type card reader module 31 and the non-connection type card reader module 32 are relative large the non-contact type card reader module 32 and the inserting type card reader module 31 are arranged side by side in said structure so as to improve the integrated level, and to reduce the occupied space, and to facilitate the arrangement and layout of other elements.

The inserting type card reader module 31 includes a magnetic head (not shown) configured for reading information from the magnetic stripe card and a card reader (not shown) configured for reading information from the chip card. The magnetic head is provided in the card slot 311 and is arranged at a side thereof far away from a recess. The card reader is arranged in the casing 10. As a result, when inserting the magnetic stripe card, the magnetic stripe on the magnetic stripe card passes through the magnetic head so as to be read. When the chip card is inserted, the chip is located at a position corresponding to the card reader so as to be read. Therefore, the inserting type card reader module 31 can read information from the magnetic stripe card and also can read information from the chip card.

Further, referring to FIG. 1 and FIG. 2, as an embodiment of the tablet POS terminal provided by the present application, an indicator light 321 is arranged in the casing 10 configured for prompting when the non-contact type card reader module 32 is being used. A light hole (not shown) is provided at the casing 10 and is arranged in a position corresponding to the indicator light 321. A power indicator light 14 is provided at the casing 10 and is arranged in a position corresponding to the top of the tablet computer module 20. A light non-opaque cover plate (not shown) configured fir covering the light hole is provided on the casing 10. Configure the indicator light 321, so that when the non-contact type card reader module 32 is being used, the indicator light 321 is turned on to carry out prompt. However, when the non-contact type card reader module 32 is not being used, the indicator light 321 is turned off. Due to the light non-opaque cover plate covers the light hole, the area on the casing 10 corresponding to the non-contact type card reader module 32 can be kept consistent with other positions so as to achieve hiding effects.

Further, referring to FIG. 1 and FIG. 2, as an embodiment of the tablet POS terminal provided by the present application, the integrated payment module 30 further includes a camera 34 configured for shooting images. The camera 34 and the fingerprint identification module 33 are respectively arranged at the two sides of the non-contact type card reader module 32. The camera 34, the non-contact type card reader module 32 and the fingerprint identification module 33 are provided at the same side of the inserting type card reader module 31. Configure the camera 34, so that camera shooting can be carried out, with face recognition can be carried out, and users' using experiences can be better improved. The camera 34 and the fingerprint identification module 33 are respectively arranged at two sides of the non-contact type card reader module 32 so as to facilitate the arrangement. Moreover, the structure of the tablet POS terminal can be more compact, and the occupied space can be reduced. Consequently, the size of the tablet POS terminal is reduced.

Further, referring to FIG. 1 and FIG. 2, as an embodiment of the tablet POS terminal provided by the present application, the integrated payment module 30 further includes a keyboard 35 configured for entering information. The keyboard 35 is arranged at the other side of the inserting type card reader module 31. Configure the keyboard 35, so that information can be conveniently input through the keyboard 35. The using safety is improved, and the comfort level of the hand feeling while inputting is improved. The keyboard 35 is arranged at the other side of the inserting type card reader module 31, so that the structure compactness of the integrated payment module 30 is further improved, and the occupied space is reduced.

Further, referring to FIG. 1 and FIG. 2, as an embodiment of the tablet POS terminal provided by the present application, the integrated payment module 30 further includes an anti-peeping cover (not shown) for covering the keyboard 35. Configure the anti-peeping cover, so that sensitive information, such as user's inputting password etc., can be better protected, and the safety is improved.

Further, referring to FIG. 1 and FIG. 2, as an embodiment of the tablet POS terminal provided by the present application, a first magnetic attraction (not shown) is provided in the casing 10 and arranged at the periphery of the keyboard 35. A second magnetic attraction is provided at the bottom of the anti-peeping cover and arranged to cooperate with the first magnetic attraction (not shown). When the user needs to enter sensitive information using the keyboard 35, the anti-peeping cover can be arranged on the casing 10; when the user does not need to input sensitive information using the keyboard 35, the anti-peeping cover can be taken off so as to reduce the occupied space of the tablet POS terminal. The first magnetic attraction and the second magnetic attraction can be mutually attracted magnets. Of course, the first magnetic attraction can be a magnet, and the second magnetic attraction can be an iron sheet and the like.

Further, referring to FIG. 1 and FIG. 2, as an embodiment of the tablet POS terminal provided by the present application, the keyboard 35 includes a plurality, of rice-grain keys 351, and holes for exposing the rice-grain keys 351 are correspondingly provided on the casing 10. As the rice-grain keys 351 being used, the occupied space can be reduced, and the keyboard 35 can be made relatively small. Meanwhile, the distance between the adjacent keys can be arranged to be relatively large so as to be operated conveniently.

Further, referring to FIG. 1 and FIG. 2, as an embodiment of the tablet POS terminal provided by the present application, a recess 16 is provided at the casing 10 and arranged in a position corresponding to one side of the card slot 311. The recess 16 is arranged to facilitate holding a card when the card is inserted into the card slot 311, so that the operation is more convenient, and the user can conveniently recognize the position of the card slot 311.

Further, referring to FIG. 1 and FIG. 2, as an embodiment of the tablet POS terminal provided by the present application, a prompt colored chart (not shown) is provided at a side surface of the casing 10 and arranged in a position corresponding to the card slot 311. The prompt colored chart is provided at the casing 10, and arranged in a position corresponding to the periphery of the card slot 311, so that the position of the card slot 311 can be highlighted.

Further, in the embodiment, the prompt colored chart is a black-orange or white-orange prompt chart, so that the position on the casing 10 corresponding to the periphery of the card slot 311 can be set to be black-orange or white-orange so as to be more outstanding. Of course, in some other embodiments, the prompt colored chart can be set to be in a color different from that of other areas on the casing 10. Specifically, the area on the casing 10 corresponding to the periphery of the card slot 311 can be set to be of different colors. Alternatively, a pasting film with prompt colors can also be attached to the area so as to prompt.

Further, referring to FIG. 1 and FIG. 3, as an embodiment of the tablet POS terminal provided b the present application, the laser scanner 36 is arranged at a side surface of the bottom of the casing 10. To laterally arrange the laser scanner 36 at the bottom of the casing 10, the occupied space can be reduced, and the utilization rate of the space on the casing can be improved so as to arrange the tablet POS terminal to be more compact. Further, the laser scanner 36 is arranged at one side of the inserting type card reader module 31 where is far away from the non-contact type card reader module 32. More specifically, the laser scanner 36 is arranged at a side of the casing corresponding to the keyboard 35 so as to further reduce the occupied space.

Further, referring to FIG. 1 and FIG. 3, as an embodiment of the tablet POS terminal provided by the present application, the thickness of a position at the casing 10 corresponding to the integrated payment module 30 is thinner than the thickness of the other side of the casing 10, so that the payment area can be recognized conveniently. Similarly, the width of a position at the casing 10 corresponding to the integrated payment module 30 is gradually reduced from a position corresponding to the computer module 20 towards the direction of the bottom side of the casing 10.

The above descriptions are only preferred embodiments of the present application, and are not intended to limit the present application. Any modification, equivalent replacement, improvement and the like, which are made within the spirit and principle of the present application, are all included in the protection scope of the present application.

1. A tablet POS terminal, comprising a casing, wherein:
said tablet POS terminal further includes a tablet computer module arranged in the casing and an integrated payment module arranged in the casing, wherein the casing is in a flat shape;
wherein a window exposing a screen of the tablet computer module is correspondingly provided at the casing;
wherein the integrated payment module is arranged at a side of the tablet computer module, and the integrated payment module is electrically connected with the tablet computer module; and
a switch button configured to control powering on and off of the tablet computer module is provided at the casing.

2. The tablet POS terminal as claimed in claim 1, wherein:
the integrated payment module includes a inserting type card reader module configured for reading information from a magnetic stripe card or a chip card; a non-contact type card reader module configured for wirelessly reading information from a non-contact card; a laser scanner configured for scanning codes; a fingerprint identification module configured for fingerprint identification; and a card slot is correspondingly provided at the casing and is configured for insertion of a magnetic strip card or a chip card into the inserting type card reader module; the card slot is arranged in the middle of the thickness of the casing.

3. The tablet POS terminal as claimed in claim 2, wherein:
the inserting type card reader module is arranged in the middle of the bottom of the casing, and the non-contact type card reader module is arranged at a side of the inserting type card reader module.

4. The tablet POS terminal as claimed in claim 3, wherein:
an indicator light is provided in the casing configured for prompting when the non-contact type card reader module is in use; a light hole is provided in the casing and is arranged at a position corresponding to the indicator light; and a light non-opaque cover plate configured for covering the light hole is provided at the casing.

5. The tablet POS terminal as claimed in claim 3, wherein:
the integrated payment module further includes a camera configured for shooting images; the camera and the fingerprint identification module are respectively arranged at two sides of the non-contact type card reader module; wherein the camera, the non-contact type card reader module and the fingerprint identification module are arranged at the same side of the inserting type card reader module.

6. The tablet POS terminal as claimed in claim 3, wherein:
the integrated payment module further includes a keyboard configured for entering information; and the keyboard is arranged at another side of the inserting type card reader module.

7. The tablet POS terminal as claimed in claim 6, wherein:
the integrated payment module further includes an anti-peeping cover configured for covering the keyboard.

8. The tablet POS terminal as claimed in claim 7, wherein:
a first magnetic attraction is provided in the casing and is arranged at the periphery of the keyboard; and
a second magnetic attraction is provided at the bottom of the anti-peeping cover and arranged to cooperate with the first magnetic attraction.

9. The tablet POS terminal as claimed in claim 6, wherein:
the keyboard includes a plurality of rice-grain keys; and holes configured for exposing the rice-grain keys are correspondingly provided at the casing.

10. The tablet POS terminal as claimed in claim 2, wherein:
a prompt colored chart is provided at a side surface of the casing and is arranged in a position corresponding to the card slot.

11. The tablet POS terminal as claimed in claim 2, wherein:
the laser scanner is laterally arranged at the bottom of the casing.
